(19) United States
(12) Patent Application Publication
(10) Pub. No.: US 2010/0044334 A1
(43) Pub. Date: Feb. 25, 2010

(54) GLASS INSERT INFANT NURSING DEVICE

(76) Inventor: Christine Barlow, Thousand Oaks, CA (US)

Correspondence Address: Lauson & Tarver LLP, 880 Apollo Street, SUITE 301, El Segundo, CA, 90245, US

(21) Appl. No.: 12/194,426

(22) Filed: Aug. 19, 2008

(51) Int. Cl. A61J 11/02; A61J 9/08; A61J 11/00

(52) U.S. Cl. 215/11.5; 215/11.6; 606/236

(57) ABSTRACT

An infant nursing device is disclosed comprising a glass fluid-containing inner vessel disposed within a plastic outer protective shell. The inner vessel contacts the outer protective shell at the neck of the device, and at the midsection and bottom of the shell. The two containers come together and are removably attached with a nipple and gasket mechanism. The gasket holds the nipple to the inner vessel and the inner vessel to the outer protective shell. When not in use, the inner vessel can be filled with fluid, and a primary cap disposed on the inner vessel to seal the contents. To use the device, the inner vessel is disposed in the outer protective shell, the nipple and gasket are attached, sealing the nipple to the inner vessel and holding fast the outer protective shell, and a secondary cap disposed over the nipple.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

Baby and infant nursing devices and bottles are known in the art. In the current art, it is common for devices for infants and babies, including nursing devices to be made of plastic or similar material, as the resiliency of plastic confers a shatter proof advantage over more breakable materials. However plastic is not an ideal material for devices used to contain infant foods or liquids, since plastic doesn't retain its temperature, can affect the flavor of consumables, and may even contribute undesired chemicals into liquids with which it comes into contact.

Glass receptacles for containing liquids are preferable in this regard because they do not interact with the fluids they contain, and depending on the thickness of the glass, also have heat sink properties, preserving the thermal conditions of the fluids they contain. However, glass receptacles are prone to shatter when striking hard surfaces. Therefore there is a need for a device that contains fluid in a glass receptacle, but provides a plastic shell to prevent the receptacle from breaking if the device is dropped.

It is therefore an object of the present invention to provide a nursing bottle for infants that comprises a glass container inside a plastic shell combining both proper fluid containing and shatter proof characteristics. A further object of the invention is to provide a plastic shell that resiliently holds a glass container and nipple for feeding an infant. Yet another object of the invention is to provide a fluid containing glass insert that can be removed from the plastic shell for cleaning and refrigeration. These and other objects will become apparent from the appended Summary, Description and Claims.

### SUMMARY

The present invention comprises an improved infant nursing device. The device further comprises an outer protective shell made of shatter proof transparent material, for protecting an inner glass vessel and for viewing the contents of the device. The outer protective shell is generally cylindrical in shape, but has an open end with a neck comprising threading along its outer circumference. While the outer protective shell is generally cylindrical, it has a narrower diameter midway along its length with a set of flattened surfaces disposed on opposite sides of its midsection with raised ridges for gripping, and a raised dome-like bottom for supporting the inner glass vessel.

The inner glass vessel of the device contains infant feeding fluids, and fits into the outer protective shell. The inner glass vessel comprises an elongated fluid holding portion with one open end comprising a rim. The inner glass vessel contacts the outer protective shell at the rim of the inner glass vessel, at the midsection of the shell, and rests on the dome at the bottom of the shell. Indicia on the surface indicate the amount of fluid in the inner glass vessel. The inner glass vessel is generally cylindrical, but comprises flattened elongated areas along its length for improved gripping.

A capping means encloses and retains the contents of the inner glass vessel when the device is not in use by an infant. The capping means comprises a resiliently deformable plug with a flange extending over the rim of the inner glass vessel, and a plug portion extending into the inside of the neck of the inner glass vessel. The capping means further comprises a retaining means, including an undercut at the junction of the flange and plug portion to further maintain the position of the capping means using a pressure fit when the inner glass vessel is fluid filled.

The outer protective shell receives the inner glass vessel, which extends into the outer protective shell until the rim of the inner glass vessel meets the neck of the outer protective shell; the capping means having been removed from the inner glass vessel. A flanged nipple and gasket are placed over the outer protective shell and inner glass vessel, wherein the gasket holds the flange of the nipple in a hermetic seal against the rim of the inner glass vessel after removal of the capping means and installation of the nipple and gasket. The gasket also holds the inner glass vessel in a static relationship to the outer protective shell.

The nipple further comprises an inlet means to allow air into the inner glass vessel as fluids are consumed. The gasket comprises a retaining member that compresses the flange of the nipple against the rim of the inner glass member and the neck of the outer protective shell, causing the glass member to compress against the raised dome at the bottom of the shell. In one preferred embodiment, the gasket further comprises a gripping means around its circumferential surface to aid in tightening the gasket over the nipple.

### FIGURES

FIG. 1 is a perspective view of the assembled infant nursing device of the present invention.

FIG. 2 is a perspective view of the outer protective shell of the device.

FIG. 3 is a perspective view of the inner glass vessel of the device with a capping means for retaining fluids.

FIG. 4 is a perspective assembly view of the outer protective shell, inner glass vessel, nipple, retaining gasket and cap of the present invention.

### DESCRIPTION

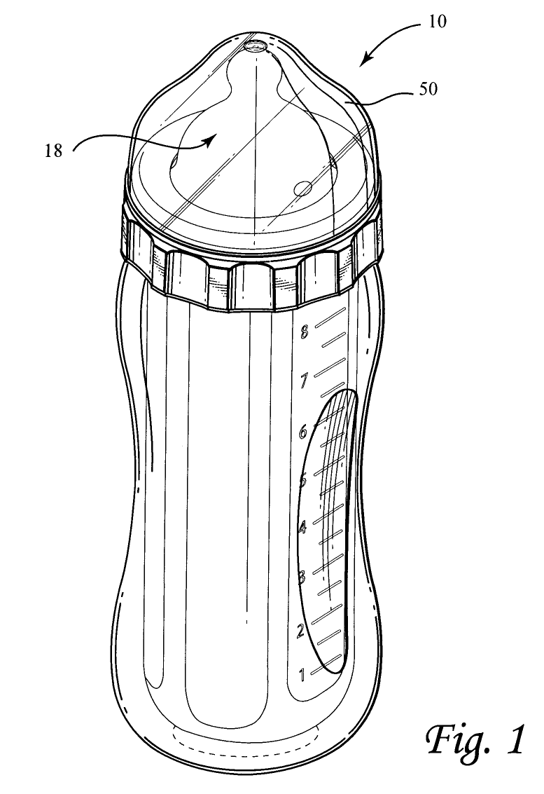

Referring to FIG. 1, the present invention comprises an improved infant nursing device 10 shown in its assembled configuration with a cap 50 enclosing and protecting the nipple 18 of the device.

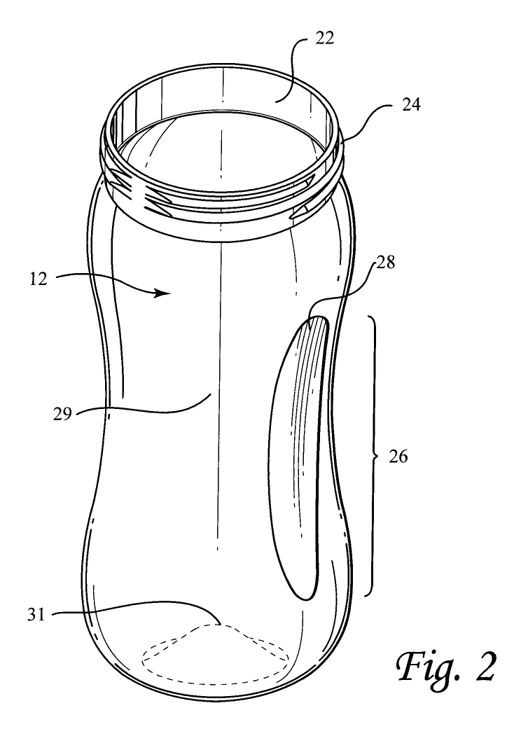

Referring to FIG. 2, the device comprises an outer protective shell 12 made of shatter proof or shatter resistant material, including plastic, plastics or resins, and should be able to withstand the impact of dropping the device, when full, from a height of at least six feet. In a preferred embodiment, the outer protective shell 12 is transparent for viewing the contents of the device. The outer protective shell 12 is generally cylindrical in shape, but has an open end with a neck 22 comprising threading 24 along its outer circumference. While the outer protective shell is generally cylindrical, it has a narrower diameter 26 midway along its length, and in one preferred embodiment, a set of flattened surfaces 28 disposed on opposite sides of the midsection 26 of the outer protective shell 12. A domed structure 31 is located at the bottom of the shell, causing the bottom of the shell to depend upward, into the shell 12 for supporting the glass portion of the bottle.

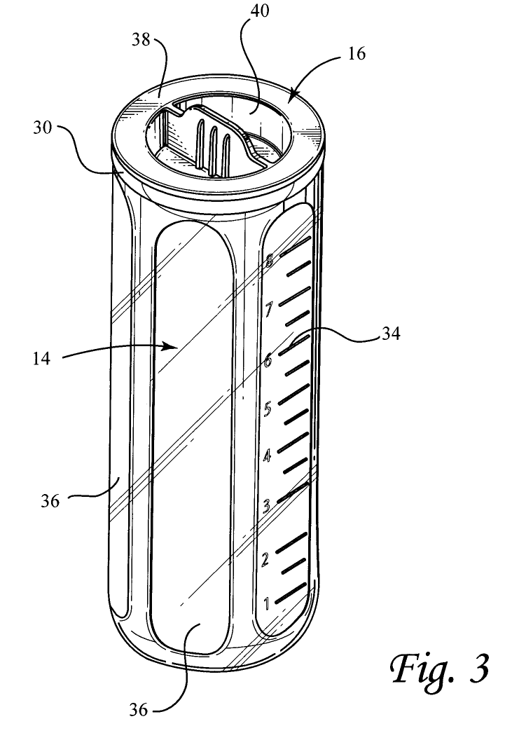

Referring to FIG. 3, the device further comprises an inner glass vessel 14 for containing infant feeding fluids, which fits into the outer protective shell. The inner glass vessel 14 comprises an elongated fluid holding portion with one open end comprising a rim 30. The inner glass vessel 14 contacts the outer protective shell at the rim 30, at the midsection of the shell (ref 29 in FIG. 2), and at the top of the domed structure (ref 31 in FIG. 2) on the bottom of the shell of the inner glass vessel 14, wherein the domed structure of the outer protective shell serves as a stop to prevent the inner glass vessel 14 from traveling completely into the outer protective shell when the device is assembled. The inner glass vessel 14 further comprises indicia 34 on its outer surface to indicate the amount of fluid in the inner glass vessel 14. The inner glass vessel 14 is generally cylindrical, but comprises flattened elongated areas 36 along its length for improved gripping.

Still referring to FIG. 3, a capping means 16 for enclosing and retaining the contents of the inner glass vessel 14 is associated with the inner glass vessel 14 when the device is not in use by an infant. The capping means 16 comprises a resiliently deformable plug with a flange 38 that extends over the rim 30 of the inner glass vessel 14, and a plug portion 40 depending into the inside of the inner glass vessel 14. The capping means 16 further comprises a retaining means, including an undercut (not shown), at the junction of the flange 38 and plug portion 40 of the capping means 16 to further maintain the position of the capping means using a pressure fit when the inner glass vessel 14 is fluid filled.

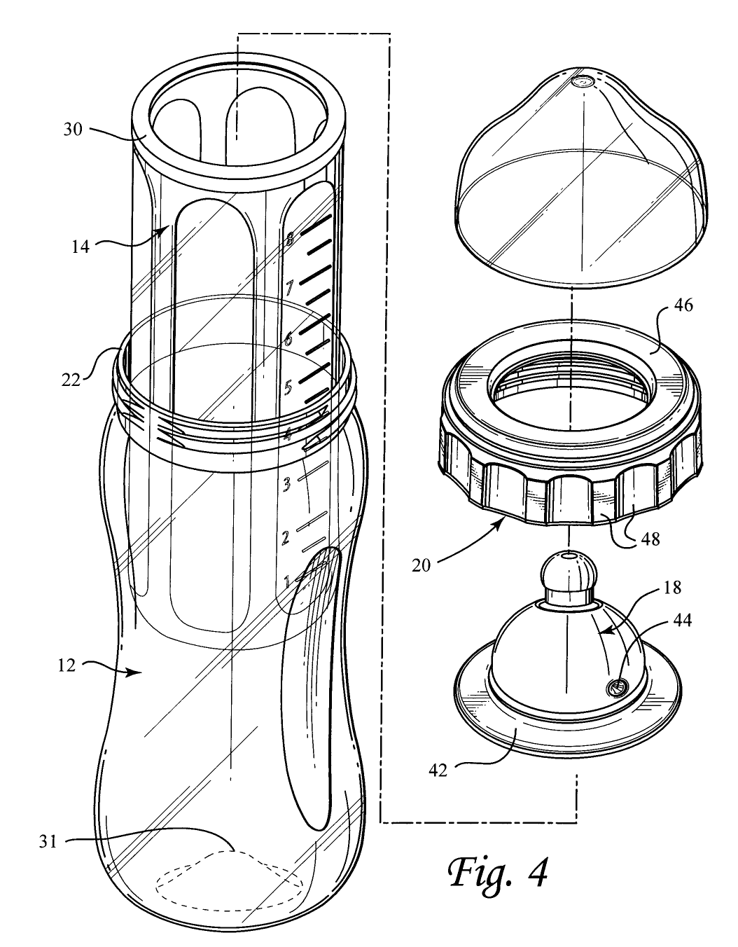

Referring to FIG. 4, an exploded view of the device being assembled for use is shown and described. The outer protective shell 12, receives the inner glass vessel 14, which extends into the outer protective shell 12 until the rim 30 of the inner glass vessel 14 meets the neck 22 of the outer protective shell 12, and the bottom of the glass vessel 14 meets the domed structure 31 of the outer protective shell 12. The capping means (not shown) having been removed from the inner glass vessel 14, a flanged nipple 18 and retainer 20 are placed over the outer protective shell 12 and inner glass vessel 14, wherein the retainer 20 holds the flange 42 of the nipple 18 hermetically sealed against the rim 30 of the inner glass vessel 14 after removal of the capping means and installation of the nipple 18 and retainer 20. The retainer 20 also holds the inner glass vessel 14 in a static relationship relative to the outer protective shell 12.

Still referring to FIG. 4, the nipple 18 further comprises an inlet means 44, governed by air pressure, to allow air into the inner glass vessel as fluids are consumed. The retainer 20 comprises a retaining portion 46 that compresses the flange 42 of the nipple 18 against the rim 30 of the inner glass vessel 14, and against the neck 22 of the outer protective shell 12. In one preferred embodiment, the retainer 20 further comprises a gripping means 48 around its circumferential surface to aid in tightening the retainer 20 over the nipple 18.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An improved infant nursing device comprising;
a. an outer protective shell comprising a shatter-resistant material;
b. an inner glass vessel for containing infant feeding fluids comprising a rim and neck, and an elongated fluid holding portion;
c. a capping means for enclosing and retaining the contents of the inner glass vessel;
d. a flanged nipple and gasket assembly wherein the gasket holds the flange of the nipple against the rim of the inner glass vessel after removal of the capping means and installation of the nipple and gasket, and wherein the gasket holds the flange of the nipple against the rim of the outer protective shell, and wherein the gasket causes the inner glass vessel to press down against a domed structure at the bottom of the outer protective shell, causing the inner glass vessel to remain in a static relationship relative to the outer protective shell when the gasket is tightened; and
e. an outer cap for enclosing the nipple when the nipple is attached to the outer protective shell.

2. The device of claim 1, wherein the outer protective shell comprises a neck with a gasket attachment means, including threading.

3. The device of claim 1, wherein the outer protective shell is generally cylindrical, but has a narrower diameter midway along its length for improved gripping.

4. The device of claim 3, wherein the portion of the outer protective shell comprising the narrower diameter contacts the sides of the inner glass vessel, holding it in a laterally static position.

5. The device of claim 1, wherein the outer protective shell comprises a material including plastic, capable of not shattering when the assembled and filled device is dropped from a height of at least six feet.

6. The device of claim 1, wherein the inner glass vessel makes contact with the outer protective shell at the neck of the inner glass vessel at the sides of the outer protective shell, and at the bottom of the glass vessel and top of the domed structure at the bottom of the outer protective shell.

7. The device of claim 1, wherein the inner glass vessel comprises indicia on its outer surface to indicate the amount of fluid in the vessel.

8. The device of claim 1, wherein the inner glass vessel is generally cylindrical, but comprises flattened elongated areas along its length for improved gripping.

9. The device of claim 1, wherein the rim of the inner glass vessel comprises an enlarged diameter that provides resistance to the gasket when the device is assembled.

10. The device of claim 1, wherein the capping means comprises a resiliently deformable plug with a flange extending over the rim of the inner glass vessel, and a plug portion extending into the inside of the neck of the inner glass vessel.

11. The device of claim 10, wherein the capping means further comprises a retaining means, including an undercut, at the junction of the flange and the plug portion to maintain the position of the capping means when the inner glass vessel is fluid filled.

12. The device of claim 10, wherein the capping means further comprises a gripping means, including a tab with raised surface features to facilitate removal of the capping means from the inner glass vessel.

13. The device of claim 1, wherein the nipple comprises a flange, which makes a hermetic seal at the rim of the inner glass vessel and the gasket.

14. The device of claim 1, wherein the nipple further comprises an inlet means, governed by air pressure, to allow air to displace fluid as fluid in the device is consumed.

15. The device of claim 13, wherein the gasket comprises a retaining member that compresses the flange of the nipple against the rim of the inner glass member, which is further compressed against the neck of the outer protective shell.

16. The device of claim 1, wherein the gasket further comprises a gripping means around its circumferential surface to aid in tightening the gasket over the nipple, inner glass member rim, and outer protective shell.

17. The device of claim 1, wherein the outer protective shell is transparent.
